(19) United States
(12) Patent Application Publication
(10) Pub. No.: US 2026/0152100 A1
(43) Pub. Date: Jun. 4, 2026

(54) ATTITUDE CONTROL DEVICE

(71) Applicant: AISIN CORPORATION, Kariya (JP)

(72) Inventors: Shintaro SUZUKI, Kariya-shi (JP); Masashi Nobutoki, Kariya-shi (JP)

(73) Assignee: AISIN CORPORATION, Kariya (JP)

(21) Appl. No.: 19/367,262

(22) Filed: Oct. 23, 2025

(30) Foreign Application Priority Data
Nov. 29, 2024 (JP) 2024-208050

(51) Int. Cl. B60N 2/50

(52) U.S. Cl. CPC B60N 2/501; B60N 2210/50; B60N 2220/20

(57) ABSTRACT

As an example, an attitude control device of embodiments includes a calculator that calculates an acceleration in a front-rear direction by using a weight and braking driving force of a mobile object, and an acceleration in a left-right direction by using a vehicle speed and a turning radius, and calculates a target seat surface angle in the front-rear direction by using the acceleration in the front-rear direction, and a target seat surface angle in the left-right direction by using the acceleration in the left-right direction.

### CROSS REFERENCE TO RELATED APPLICATIONS

This application is based on and claims priority under 35 U.S.C. § 119 to Japanese Patent Application No. 2024-208050, filed on Nov. 29, 2024, the entire content of which is incorporated herein by reference.

### TECHNICAL FIELD

Embodiments of the present disclosure relate to an attitude control device.

### BACKGROUND DISCUSSION

For example, Japanese Patent Application Laid-Open No. 2020-075690 discloses a vehicle control device in which acceleration is detected by an acceleration sensor mounted on a vehicle, and, on the basis of the detected acceleration, influence of the acceleration is reduced.

However, in a case where acceleration detected by the acceleration sensor is used, for example, if up-down movement of the vehicle occurs due to disturbance such as unevenness of a road surface, acceleration in a front-rear direction and a left-right direction may change, and unnecessary control may be performed.

Therefore, one of the objects of the embodiments is to provide an attitude control device capable of acquiring acceleration in the front-rear direction and left-right direction of a mobile object without using an acceleration sensor and performing attitude control on the basis of the acquired acceleration.

A need thus exists for an attitude control device which is not susceptible to the drawback mentioned above.

### SUMMARY

As an example, an attitude control device of embodiments includes a calculator that calculates an acceleration in a front-rear direction by using a weight and braking driving force of a mobile object, and an acceleration in a left-right direction by using a vehicle speed and a turning radius, and calculates a target seat surface angle in the front-rear direction by using the acceleration in the front-rear direction, and a target seat surface angle in the left-right direction by using the acceleration in the left-right direction.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a block diagram showing an example of a configuration of an attitude control system for a vehicle to which an attitude control device according to a first embodiment is applied;

FIG. 2 is a flowchart showing an example of processing by the attitude control device according to the first embodiment;

FIG. 3 is a flowchart showing an example of processing in a case where a road surface friction coefficient by the attitude control device according to the first embodiment is equal to or greater than a predetermined value;

FIG. 4 is a flowchart showing an example of processing of controlling seat surface angles by the attitude control device according to the first embodiment;

FIG. 5 is a block diagram showing an example of a configuration of an attitude control system for a vehicle to which an attitude control device according to a second embodiment is applied; and

FIG. 6 is a flowchart showing an example of processing corresponding to a state of an occupant or selection by the occupant, by the attitude control device according to the second embodiment.

### DETAILED DESCRIPTION

Hereinafter, an attitude control device of the present embodiments will be described with reference to the drawings. The configurations of the embodiments described below and functions and effects brought about by the configurations are merely an example, and the present disclosure is not limited to the following description.

In the following description, a “front-rear direction” refers to a direction parallel to a direction in which a mobile object travels. The “left-right direction” is a direction perpendicular to the direction in which the mobile object travels, and represents a direction parallel to ground.

The mobile object is an object that is able to move, and is, for example, a vehicle, a robot, or the like. In the embodiments, a case where the mobile object is a vehicle will be described as an example. A backrest may be integrally provided on the seat surface in the vehicle. Control of a seat surface angle includes, for example, controlling the seat surface angle by which the backrest also moves integrally.

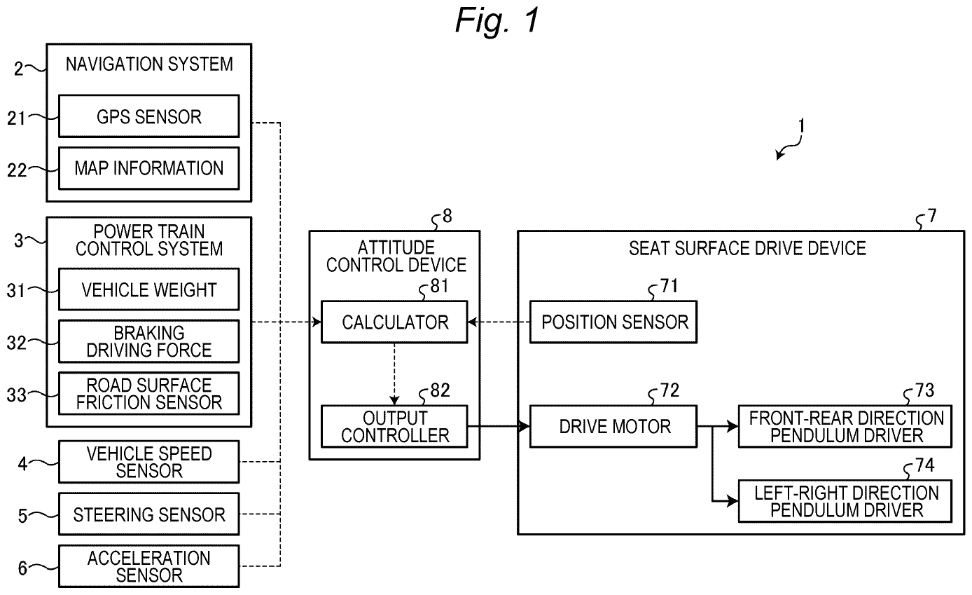

FIG. 1 is a block diagram showing an example of a configuration of an attitude control system 1 for a vehicle to which an attitude control device 8 according to a first embodiment is applied.

The attitude control system 1 includes a navigation system 2, a power train control system 3, a vehicle speed sensor 4, a steering sensor 5, an acceleration sensor 6, the attitude control device 8, and a seat surface drive device 7.

The attitude control system 1 calculates the acceleration a₁ [m/s²] in the front-rear direction of the vehicle and the acceleration a₂ [m/s²] in the left-right direction of the vehicle. The attitude control system 1 calculates a target seat surface angle θ_{VT} [deg] in the front-rear direction and a target seat surface angle θ_{HT} [deg] in the left-right direction of the seat surface mounted in the vehicle by using the calculated acceleration a₁ in the front-rear direction and acceleration a₂ in the left-right direction. The attitude control system 1 adjusts a seat surface angle θ_{V} [deg] in the front-rear direction and a seat surface angle θ_{H} [deg] in the left-right direction by the seat surface drive device 7.

The navigation system 2 includes a global positioning system (GPS) sensor 21 and map information 22.

The GPS sensor 21 acquires data for estimating a location of the vehicle.

The map information 22 includes, for example, information regarding at least a road surface inclination angle θ_{d} [deg] in the front-rear direction of an uphill, downhill, flat road, or the like, a road curvature radius r₁ [m] in the traveling direction, and a junction such as an intersection.

The power train control system 3 has a vehicle weight m[kg] 31, a braking driving force F[N] 32, and a road surface friction sensor 33.

The vehicle weight m31 is information regarding a weight of the vehicle to which the attitude control device 8 is applied. The vehicle weight m31 is also referred to as a weight of the mobile object.

The braking driving force F32 is, for example, a braking force detected from a brake operation amount, or a driving force detected from an acceleration operation amount.

The road surface friction sensor 33 detects a road surface friction coefficient μ.

The vehicle speed sensor 4 is a sensor that detects a rotation amount of wheels, or a rotation rate of the wheels per unit time. The vehicle speed sensor 4 calculates a vehicle speed v [m/s] from the rotation amount or the rotation rate. Note that the vehicle speed v also includes speed of the mobile object.

The steering sensor 5 detects a steering angle θₛ [deg] from a steering operation amount.

The acceleration sensor 6 detects the acceleration a₁ in the front-rear direction of the vehicle, the acceleration a₂ in the left-right direction of the vehicle, and an acceleration a₄ in an up-down direction of the vehicle.

The seat surface drive device 7 includes a position sensor 71, a drive motor 72, a front-rear direction pendulum driver 73, and a left-right direction pendulum driver 74.

The position sensor 71 detects, for example, the seat surface angle θ_{V} in the front-rear direction and the seat surface angle θ_{H} in the left-right direction.

The drive motor 72 drives, for example, the front-rear direction pendulum driver 73 in the front-rear direction. The drive motor 72 drives, for example, the left-right direction pendulum driver 74 in the left-right direction. The drive motor 72 drives the front-rear direction pendulum driver 73 and the left-right direction pendulum driver 74 under control of the attitude control device 8, for example.

The front-rear direction pendulum driver 73 is a mechanism for causing the seat surface to perform pendulum operation in the front-rear direction so as to reduce influence of the acceleration a₁ in the front-rear direction, when, for example, the vehicle accelerates or decelerates in the front-rear direction by which the acceleration a₁ in the front-rear direction occurs to the vehicle. The front-rear direction pendulum driver 73 can reduce movement of an occupant seated on the seat surface in the front-rear direction due to influence of the acceleration or deceleration.

The left-right direction pendulum driver 74 is a mechanism for causing the seat surface to perform the pendulum operation in the left-right direction so as to reduce influence of the acceleration a₂ in the left-right direction, when, for example, the vehicle turns in the left-right direction by which the acceleration a₂ in the left-right direction occurs to the vehicle. The left-right direction pendulum driver 74 can reduce movement of the occupant seated on the seat surface in the left-right direction due to influence of the turning movement.

The attitude control device 8 includes a calculator 81 and an output controller 82.

The calculator 81 acquires the vehicle weight m31 and the braking driving force F32, and calculates the acceleration a₁ in the front-rear direction by using the vehicle weight m31 and the braking driving force F32.

The calculator 81 acquires the vehicle speed v from the vehicle speed sensor 4. The calculator 81 calculates a turning radius r₂ [m] on the basis of the steering angle θₛ acquired from the steering sensor 5.

The calculator 81 acquires information from the GPS sensor 21 and the map information 22, and determines whether or not a distance between a current location of the vehicle and a first reference location is within a predetermined value. Here, the first reference location is, for example, a junction such as an intersection. The distance between the current location of the vehicle and the first reference location is a distance between the current location of the vehicle and a junction such as an intersection (for example, the current location of the vehicle is several meters before the junction such as the intersection). Note that the calculator 81 may acquire the map information 22 in advance.

When determining that the distance between the current location and the first reference location is within the predetermined value, that is, when determining that the vehicle is close to the junction, the calculator 81 calculates the acceleration a₂ in the left-right direction by using the vehicle speed v and the turning radius r₂. When determining that the distance between the current location and the first reference location is longer than the predetermined distance, the calculator 81 calculates the acceleration a₂ in the left-right direction by using the vehicle speed v and the road curvature radius r₁ in the traveling direction.

The calculator 81 acquires the road surface friction coefficient μ from the road surface friction sensor 33, and determines whether or not the road surface friction coefficient μ is smaller than a predetermined value set in advance.

When determining that the road surface friction coefficient μ is smaller than the predetermined value, that is, when determining that the vehicle is likely to slip, the calculator 81 changes the acceleration a₁ in the front-rear direction and acceleration a₂ in the left-right direction calculated to values of the acceleration a₁ in the front-rear direction and acceleration a₂ in the left-right direction that are acquired from the acceleration sensor 6.

When determining that the road surface friction coefficient μ is equal to or greater than the predetermined value, that is, when determining that the vehicle is less likely to slip, the calculator 81 acquires the road curvature radius r₃ [m] at a second reference location to which the vehicle moves from the current location of the vehicle. Here, the second reference location is, for example, a location to which the vehicle moves from the current location of the vehicle by a predetermined distance farther than the first reference location. It is assumed that the distance L [m] is a distance between the current location and the second reference location. The calculator 81 calculates a predicted acceleration a₃ [m/s²] in the left-right direction of the second reference location by using the vehicle speed v and the road curvature radius r₃ at the second reference location.

The calculator 81 calculates a jerk by using the acceleration a₂ in the left-right direction and the predicted acceleration a₃ in the left-right direction, and determines whether or not the jerk is greater than a predetermined value set in advance.

When determining that the jerk is greater than the predetermined value, the calculator 81 calculates the target seat surface angle θ_{HT} in the left-right direction by using the acceleration a₂ in the left-right direction and the predicted acceleration a₃ in the left-right direction. When determining that the jerk is equal to or smaller than the predetermined value, the calculator 81 calculates the target seat surface angle θ_{HT} in the left-right direction by using the acceleration a₂ in the left-right direction.

The calculator 81 calculates the target seat surface angle θ_{VT} in the front-rear direction by using at least the acceleration a₁ in the front-rear direction. The calculator 81 calculates the target seat surface angle θ_{VT} in the front-rear direction by using, for example, the acceleration a₁ and road surface inclination angle θ_{d} in the front-rear direction.

The calculator 81 acquires the seat surface angle θ_{V} in the front-rear direction and the seat surface angle θ_{H} in the left-right direction from the position sensor 71.

The output controller 82 controls the current seat surface angle θ_{V} in the front-rear direction and seat surface angle θ_{H} in the left-right direction so that the seat surface angle θ_{V} in the front-rear direction and the seat surface angle θ_{H} in the left-right direction reach the target seat surface angle θ_{VT} in the front-rear direction and the target seat surface angle θ_{HT} in the left-right direction.

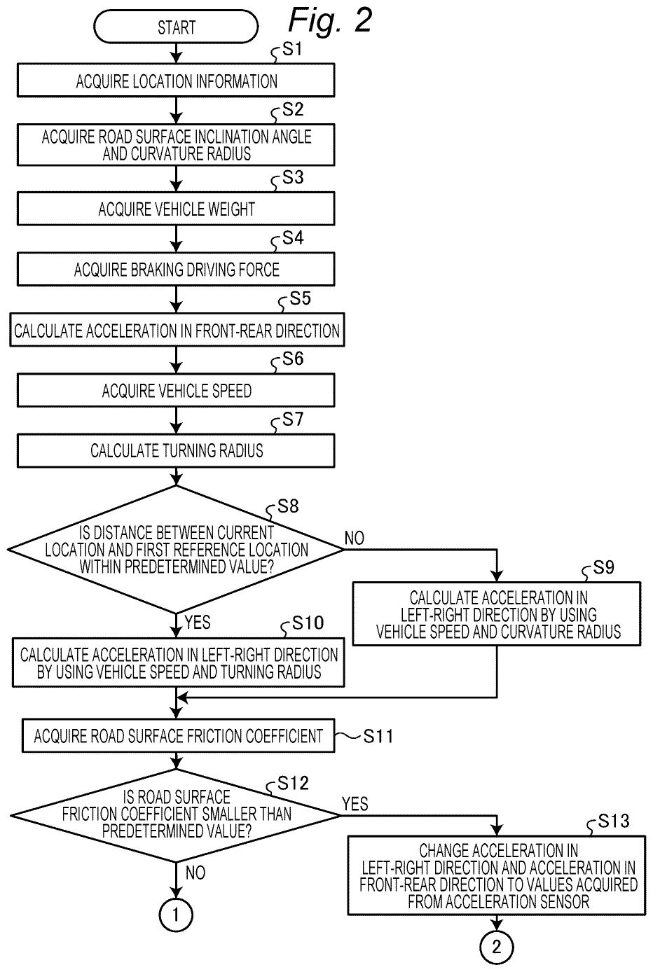

FIG. 2 is a flowchart showing an example of processing by the attitude control device 8 according to the first embodiment. As shown in FIG. 2, the calculator 81 of the attitude control device 8 acquires current location information of the vehicle from the GPS sensor 21 (Step S1). The calculator 81 may acquire the map information 22 or may acquire the map information 22 in advance.

The calculator 81 acquires the road surface inclination angle θ_{d} and the road curvature radius r₁ in the traveling direction by using the location information and the map information 22 (Step S2).

The calculator 81 acquires the vehicle weight m31 (Step S3).

The calculator 81 acquires the braking driving force F32 (Step S4).

The calculator 81 calculates the acceleration a₁ in the front-rear direction by using the vehicle weight m31 and the braking driving force F32 (Step S5). For example, the acceleration a₁ in the front-rear direction is calculated by a₁=9.8×m/F.

The calculator 81 acquires the vehicle speed v from the vehicle speed sensor 4 (Step S6).

The calculator 81 acquires the steering angle θₛ from the steering sensor 5. The calculator 81 calculates the turning radius r₂ on the basis of the acquired steering angle θₛ (Step S7). For example, the turning radius r₂ is calculated by r₂=θₛ×k₁. Note that k₁ is a turning radius conversion coefficient.

The calculator 81 determines whether or not the distance between the current location of the vehicle and the first reference location is within the predetermined value (Step S8).

When determining that the distance between the current location of the vehicle and the first reference location is longer than the predetermined distance (Step S8: No), the calculator 81 calculates the acceleration a₂ in the left-right direction by using the vehicle speed v and the road curvature radius r₁ in the traveling direction (Step S9). For example, the acceleration a₂ in the left-right direction is calculated by a₂=v²/r₁.

When determining that the distance between the current location and the first reference location of the vehicle is within the predetermined distance, that is, when determining that the vehicle is close to the junction (Step S8: Yes), the calculator 81 calculates the acceleration a₂ in the left-right direction by using the vehicle speed v and the turning radius r₂ (Step S10). For example, the acceleration a₂ in the left-right direction is calculated by a₂ =v²/r₂.

The calculator 81 acquires the road surface friction coefficient μ from the road surface friction sensor 33 (Step S11).

The calculator 81 determines whether or not the road surface friction coefficient μ is smaller than the predetermined value (Step S12).

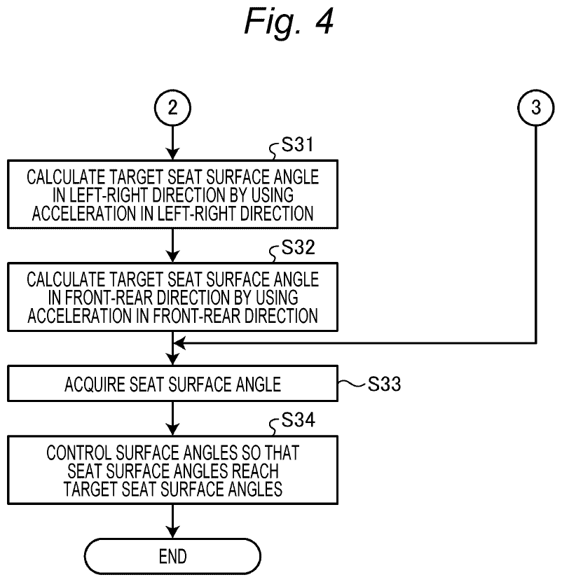

When determining that the road surface friction coefficient μ is smaller than the predetermined value (Step S12: Yes), that is, when determining that the vehicle is likely to slip, the calculator 81 changes the acceleration a₁ in the front-rear direction and acceleration a₂ in the left-right direction calculated to values of the acceleration a₁ in the front-rear direction and acceleration a₂ in the left-right direction that are acquired from the acceleration sensor 6. Then, the processing proceeds to Step S31 shown in FIG. 4 (Step S13).

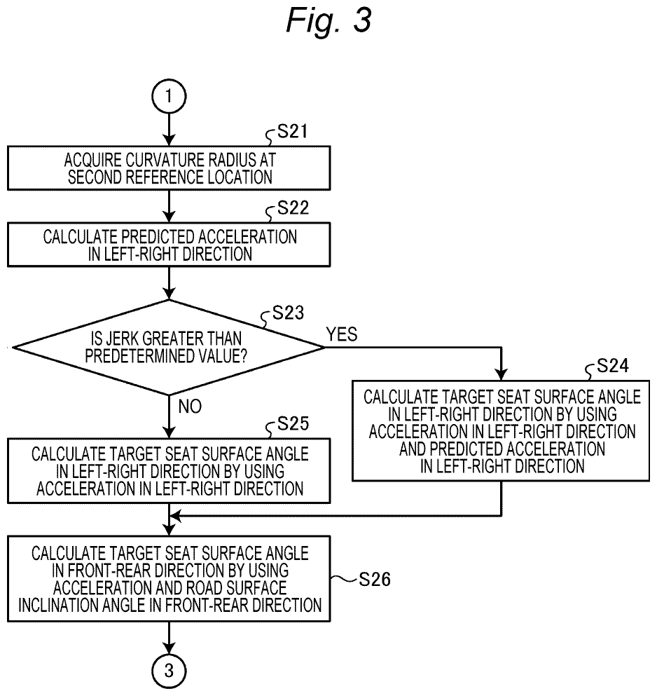

When determining that the road surface friction coefficient μ is equal to or greater than the predetermined value (Step S12: No), that is, when determining that the vehicle is less likely to slip, the calculator 81 proceeds to Step S21 shown in FIG. 3.

FIG. 3 is a flowchart showing an example of processing when the road surface friction coefficient μ by the attitude control device 8 according to the first embodiment is equal to or greater than the predetermined value.

As shown in FIG. 3, the calculator 81 acquires the road curvature radius r₃ at the second reference location to which the vehicle moves from the current location, by using the current location information of the vehicle and the map information 22. (Step S21).

The calculator 81 calculates the predicted acceleration a₃ in the left-right direction of the second reference location by using the vehicle speed v and the road curvature radius r₃ at the second reference location (Step S22).

The calculator 81 calculates the jerk by using the acceleration a₂ in the left-right direction and the predicted acceleration a₃ in the left-right direction, and determines whether or not the jerk is greater than the predetermined value (Step S23). For example, the jerk is calculated by |a₃−a₂|/(L/v).

When determining that the jerk is greater than the predetermined value (Step S23: Yes), the calculator 81 calculates the target seat surface angle θ_{HT} in the left-right direction by using the acceleration a₂ in the left-right direction and the predicted acceleration a₃ in the left-right direction (Step S24).

For example, the target seat surface angle θ_{HT} in the left-right direction is calculated by θ_{HT}=(a₂+(a₃−a₂)/k₃)k₂. Note that k₃ represents a jerk reduction coefficient, and k₂ represents a seat-surface-angle conversion coefficient.

When determining that the jerk is equal to or smaller than the predetermined value (Step S23: No), the calculator 81 calculates the target seat surface angle θ_{HT} in the left-right direction by using the acceleration a₂ in the left-right direction (Step S25).

For example, the target seat surface angle θ_{HT} in the left-right direction is calculated by θ_{HT}=a₂·k₂.

The calculator 81 calculates the target seat surface angle θ_{VT} in the front-rear direction by using the acceleration a₁ and road surface inclination angle θ_{d} in the front-rear direction. Then, the processing proceeds to Step S33 shown in FIG. 4 (Step S26).

For example, the target seat surface angle θ_{VT} in the front-rear direction is calculated by θ_{VT}=a₁·k₂+θ_{d}.

FIG. 4 is a flowchart showing an example of processing of controlling the seat surface angles θ_{V}, θ_{H} by the attitude control device 8 according to the first embodiment.

As shown in FIG. 4, after the processing in Step S13, similarly to Step S25, the calculator 81 calculates the target seat surface angle θ_{HT} in the left-right direction by using the acceleration a₂ in the left-right direction (Step S31).

The calculator 81 calculates the target seat surface angle θ_{VT} in the front-rear direction by using the acceleration a₁ in the front-rear direction (Step S32). For example, the target seat surface angle θ_{VT} in the front-rear direction is calculated by θ_{VT}=a₁·k₂.

The calculator 81 acquires the current seat surface angle θ_{V} in the front-rear direction and the seat surface angle θ_{H} in the left-right direction from the position sensor 71 (Step S33).

The output controller 82 controls the current seat surface angle θ_{V} in the front-rear direction and seat surface angle θ_{H} in the left-right direction so that the seat surface angle θ_{V} in the front-rear direction and the seat surface angle θ_{H} in the left-right direction reach the target seat surface angle θ_{VT} in the front-rear direction and the target seat surface angle θ_{HT} in the left-right direction. (Step S34).

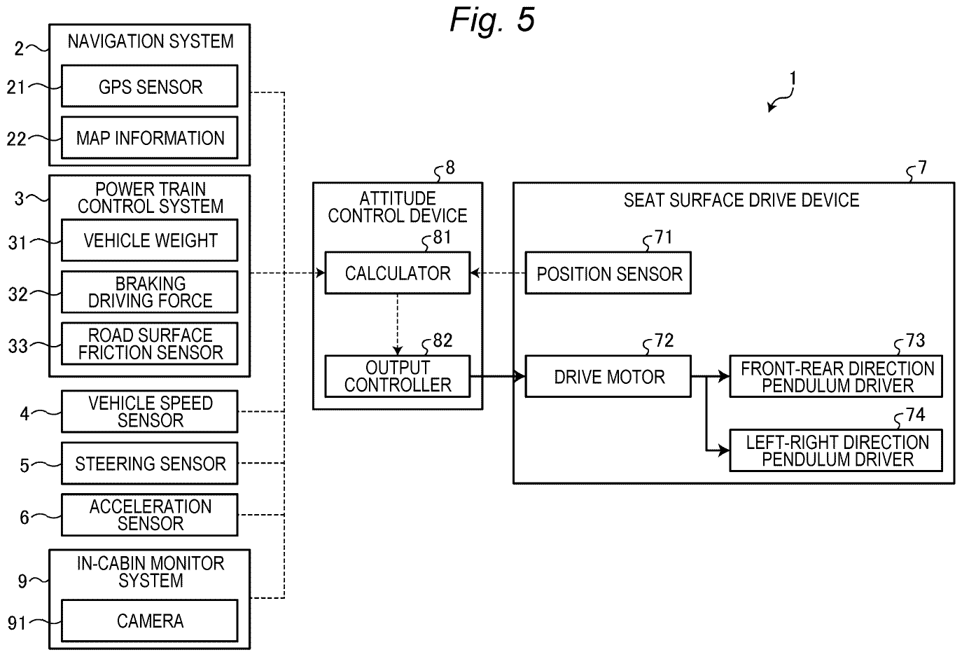

FIG. 5 is a block diagram showing an example of a configuration of an attitude control system 1 for a vehicle to which an attitude control device 8 according to a second embodiment is applied. Note that description of configurations similar to configurations of the first embodiment will be omitted. In the second embodiment, processing of switching to a control mode corresponding to a state of an occupant or selection by the occupant, regardless of a calculated acceleration, will be described.

As shown in FIG. 5, the attitude control system 1 further includes an in-cabin monitor system 9. The in-cabin monitor system 9 includes a camera 91.

The camera 91 is a device that acquires imaging data obtained by imaging the occupant seated on a seat surface. The camera 91 acquires, for example, imaging data including a face of a driver. The camera 91 analyzes the imaging data to acquire, for example, information regarding a change in appearance such as movement of a line of sight, eye movement, or body movement of the driver. Specifically, from the imaging data, the camera 91 can acquire an abnormal state such as a state in which the driver dozes off or loses consciousness.

A calculator 81 judges whether or not the control mode corresponding to the state of the occupant is to be switched. For example, when acquiring, from the camera 91, information indicating that the occupant is in the abnormal state, the calculator 81 judges that the control mode is to be switched.

For example, in a case where the calculator 81 judges from the state of the occupant that the control mode is to be switched, an output controller 82 switches to the control mode corresponding to a state of the occupant, and controls the drive motor 72. In the control mode corresponding to the state of the occupant, for example, the occupant feels uncomfortable with vibration of the seat surface by a predetermined amount or more, and is urged to return from the abnormal state to a normal state.

As an example in which the in-cabin monitor system 9 is not used, in a case where, for example, it is selected that the control mode is switched according to an intention of the occupant, the calculator 81 judges that the control mode is to be switched. For example, in a case where the control mode is released by the occupant so as not to perform attitude control, the calculator 81 judges that the control mode is to be switched.

For example, when the calculator 81 judges that the control mode is to be switched according to the selection by the occupant, the output controller 82 may release the attitude control mode.

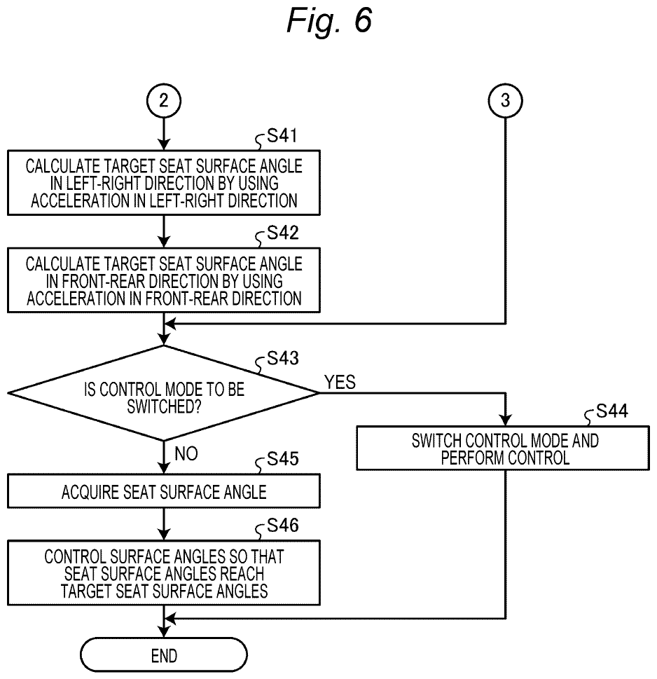

FIG. 6 is a flowchart showing an example of processing corresponding to the state of the occupant or selection by the occupant, by the attitude control device 8 according to the second embodiment.

Step S41 shown in FIG. 6 is similar to Step S31 of the first embodiment. Step S42 is similar to Step S32 of the first embodiment. Therefore, description of Steps S41 and S42 is omitted. Step S43 is processing after Step S26 of the first embodiment.

The calculator 81 judges whether or not the control mode is to be switched according to the state of the occupant or the selection by the occupant (Step S43).

When the calculator 81 judges that the control mode is to be switched according to the state of the occupant or the selection by the occupant (Step S43: Yes), the output controller 82 switches to the control mode corresponding the state of the occupant or the selection by the occupant, and controls the drive motor 72 (Step S44).

When judging that it is not necessary to switch the control mode according to the state of the occupant or the selection by the occupant (Step S43: No), the calculator 81 acquires a current seat surface angle θ_{V} in a front-rear direction and a seat surface angle θ_{H} in a left-right direction from the position sensor 71 (Step S45).

The output controller 82 controls the current seat surface angle θ_{V} in the front-rear direction and seat surface angle θ_{H} in the left-right direction so that the seat surface angle θ_{V} in the front-rear direction and the seat surface angle θ_{H} in the left-right direction reach a target seat surface angle θ_{VT} in the front-rear direction and a target seat surface angle θ_{HT} in the left-right direction (Step S46).

In the present embodiment, control of seat surface angles of the vehicle has been described as an example. As a modification, seat surface angles of a mobile object in which a seat surface does not include a backrest may be controlled.

A program for causing a computer to execute processing for implementing functions of the attitude control device described above can be provided by being recorded in a file in an installable format or an executable format, on a computer-readable recording medium such as a compact disc (CD)-ROM, a flexible disk (FD), a CD-R (recordable), and a digital versatile disk (DVD). Further, the program may be provided or distributed via a network such as the Internet.

The embodiment of the present disclosure have been described above, but the above-described embodiment and modifications thereof are merely examples, and are not intended to limit the scope of the disclosure. The above-described novel embodiment and modifications can be implemented in various forms, and various omissions, substitutions, and modifications may be made without departing from the gist of the disclosure. The above-described embodiment and modifications are included in the scope and gist of the disclosure, and are included in the disclosure described in the claims and equivalent scope thereof.

### Summary of Present Embodiments

The present embodiments include at least the following configurations.

An attitude control device (8) of the embodiments includes a calculator (81) that calculates an acceleration (a₁) in the front-rear direction by using a weight (31) and braking driving force (32) of a mobile object, and an acceleration (a₂) in a left-right direction by using a vehicle speed and a turning radius of a mobile object, and calculates a target seat surface angle (θ_{VT}) in the front-rear direction by using the acceleration (a₁) in the front-rear direction, and a target seat surface angle (θ_{HT}) in the left-right direction by using the acceleration (a₂) in the left-right direction.

According to this configuration, the attitude control device can calculate the accelerations in the front-rear direction and left-right direction of the mobile object without using the acceleration sensor, and calculate the target seat surface angles by using the accelerations. Therefore, for example, in a case where the mobile object moves up and down, it is possible to reduce changes occurring to the accelerations in the front-rear direction and the left-right direction, and to accurately calculate the target seat surface angles.

Here, conventionally, in a case where the attitude control device acquires the accelerations by using the acceleration sensor, for example, in a case where one wheel of the vehicle goes over unevenness on the road surface, the attitude control device is affected by up-down vibration. With the attitude control device, even when the vehicle is not accelerating, decelerating, or turning, the acceleration in the front-rear direction and the acceleration in the left-right direction may be changed due to the influence of the up-down vibration. As a result, the attitude control device may perform unnecessary attitude control.

In addition, conventionally, the attitude control device can reduce influence of the up-down vibration by acquiring the acceleration in the front-rear direction and the acceleration in the left-right direction by using the acceleration sensor and setting a low-pass filter or the like for the acquired values. However, by setting the low-pass filter or the like with the attitude control device, a time delay may occur with respect to the acceleration changes. As a result, with the attitude control device, an effect of the attitude control may be reduced, and the influence of the acceleration changes may be promoted.

As compared with a prior art, in a case where, for example, the mobile object moves up and down, the attitude control device of the embodiments can reduce changes occurring to the accelerations in the front-rear direction and the left-right direction, and to accurately calculate the target seat surface angles. In addition, because the attitude control device does not set a low-pass filter or the like, no time delay occurs.

In addition, for example, in a case where the attitude control device constantly performs the attitude control in accordance with a steering operation or acceleration/deceleration operation by the driver, the attitude control device may adversely affect ride comfort of the occupant.

Therefore, the attitude control device (8) of the embodiments can determine whether or not the distance between the current location of the vehicle and the first reference location is within the predetermined value, and change the value used for calculating the acceleration (a₂) in the left-right direction between the turning radius (r₂) and the curvature radius (r₁) according to a result of the determination.

As a result, the attitude control device can change between performing attitude control by using steering operation by the driver and performing attitude control according to the curvature of the road in the traveling direction, for example, and thus can perform attitude control according to the operation by the driver at necessary timing.

In the attitude control device (8) of the embodiments, for example, in a case where a road surface friction coefficient is smaller than a predetermined value, the calculator (81) sets the acceleration (a₁) in the front-rear direction and the acceleration (a₂) in the left-right direction to values acquired from an acceleration sensor (6).

According to this configuration, even when the road surface friction coefficient is smaller than the predetermined value, the attitude control device can accurately calculate the target seat surface angles by using the values acquired from the acceleration sensor.

In the attitude control device (8) of the embodiments, for example, the calculator (81) calculates a predicted acceleration (a₃) in the left-right direction at a location to which a mobile object moves by a predetermined distance, by using a speed of the mobile object and a road curvature radius at a location to which the mobile object moves by a predetermined distance, calculates a jerk by using the acceleration(a₂) in the left-right direction and the predicted acceleration (a₃) in the left-right direction, and, in a case where the jerk is greater than a predetermined value, calculates a target seat surface angle(θ_{HT}) in the left-right direction by using the acceleration (a₂) in the left-right direction and the predicted acceleration (a₃) in the left-right direction.

According to this configuration, the attitude control device calculates the predicted acceleration in the left-right direction at the location to which the vehicle moves by the predetermined distance, and in a case where the jerk is greater than the predetermined value, calculates the target seat surface angle in the left-right direction by using the acceleration in the left-right direction and the predicted acceleration in the left-right direction, by which the attitude control device can reduce a sudden change in the seat surface angles and reduce influence on the occupant.

An attitude control device (8) according to the embodiments further includes an output controller (82) that controls a seat surface angle (θ_{V}) in the front-rear direction and a seat surface angle (θ_{H}) in the left-right direction so that, for example, the seat surface angles reach the target seat surface angle (θ_{VT}) in the front-rear direction and the target seat surface angle(θ_{HT}) in the left-right direction, in which, in a case where the calculator judges, on the basis of a state of an occupant or selection by the occupant, that a control mode is to be switched, the output controller (82), regardless of a calculated acceleration, switches to a control mode corresponding to a state of the occupant or selection by the occupant and performs control.

According to this configuration, the attitude control device can switch to a control mode in which vibration is applied to the seat surface, the attitude control is not performed, or the like according to the state of the occupant or the selection by the occupant.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. An attitude control device comprising a calculator that calculates an acceleration in a front-rear direction by using a weight and braking driving force of a mobile object, and an acceleration in a left-right direction by using a vehicle speed and a turning radius, and calculates a target seat surface angle in a front-rear direction by using the acceleration in a front-rear direction, and a target seat surface angle in a left-right direction by using the acceleration in a left-right direction.

2. The attitude control device according to claim 1, wherein,
in a case where a road surface friction coefficient is smaller than a predetermined value, the calculator sets the acceleration in a front-rear direction and the acceleration in a left-right direction to values acquired from an acceleration sensor.

3. The attitude control device according to claim 1, wherein
the calculator
calculates a predicted acceleration in a left-right direction at a location to which a mobile object moves by a predetermined distance, by using a speed of the mobile object and a road curvature radius at a location to which the mobile object moves by a predetermined distance,
calculates a jerk by using the acceleration in a left-right direction and the predicted acceleration in a left-right direction, and,
in a case where the jerk is greater than a predetermined value, calculates a target seat surface angle in a left-right direction by using the acceleration in a left-right direction and the predicted acceleration in a left-right direction.

4. The attitude control device according to claim 2, wherein
the calculator
calculates a predicted acceleration in a left-right direction at a location to which a mobile object moves by a predetermined distance, by using a speed of the mobile object and a road curvature radius at a location to which the mobile object moves by a predetermined distance,
calculates a jerk by using the acceleration in a left-right direction and the predicted acceleration in a left-right direction, and,
in a case where the jerk is greater than a predetermined value, calculates a target seat surface angle in a left-right direction by using the acceleration in a left-right direction and the predicted acceleration in a left-right direction.

5. The attitude control device according to claim 1, further comprising an output controller that controls a seat surface angle in a front-rear direction and a seat surface angle in a left-right direction so that the seat surface angles reach the target seat surface angle in a front-rear direction and the target seat surface angle in a left-right direction, wherein,
in a case where the calculator judges, on the basis of a state of an occupant or selection by an occupant, that a control mode is to be switched, the output controller, regardless of a calculated acceleration, switches to a control mode corresponding to a state of an occupant or selection by an occupant and performs control.

6. The attitude control device according to claim 2, further comprising an output controller that controls a seat surface angle in a front-rear direction and a seat surface angle in a left-right direction so that the seat surface angles reach the target seat surface angle in a front-rear direction and the target seat surface angle in a left-right direction, wherein,
in a case where the calculator judges, on the basis of a state of an occupant or selection by an occupant, that a control mode is to be switched, the output controller, regardless of a calculated acceleration, switches to a control mode corresponding to a state of an occupant or selection by an occupant and performs control.
